(19) United States
(12) Patent Application Publication
(10) Pub. No.: US 2002/0080278 A1
(43) Pub. Date: Jun. 27, 2002

(54) Displaying apparatus and method for controlling the same

(76) Inventors: Joo-Hyoung Lee, Suwon City (KR); Seong-Bo Kim, Suwon City (KR); Joong-Yeol Kwon, Suwon City (KR)

Correspondence Address: Robert E. Bushnell, Suite 300, 1522 K Street, N.W., Washington, DC, 20005, US

(21) Appl. No.: 09/885,100

(22) Filed: Jun. 21, 2001

(30) Foreign Application Priority Data
Dec. 22, 2000 (KR) 80489/2000

(51) Int. Cl. H04N 5/46; H04N 9/64

(52) U.S. Cl. 348/576; 348/557

(57) ABSTRACT

A displaying apparatus comprises: a displaying part for displaying a picture; a selection input part for selecting for display a highlight portion within the picture of the displaying part; a storage part for storing data according to the selection made through the selection input part; and a controller for generating a highlight signal corresponding to the highlight portion based on the selected data, for composing or combining the highlight signal and the video signal to thereby generate a composed or combined video signal, and for displaying the highlight portion within the picture of the displaying part based on the composed or combined video signal. With this configuration, the size, position and brightness of a highlight portion can be adjusted, as desired, by specifying the highlight portion within a picture of a displaying part. A method for controlling such a displaying apparatus includes steps corresponding to the functions of the various components of the displaying apparatus, as described above.

### CLAIM OF PRIORITY

This application makes reference to, incorporates the same herein, and claims all benefits accruing under 35 U.S.C. §119 from my application DISPLAY APPARATUS AND CONTROL METHOD THEREOF filed with the Korean Industrial Property Office on Dec. 22, 2000 and there duly assigned Serial No. 80489/2000.

### BACKGROUND OF THE INVENTION

1. Technical Field

The present invention generally relates to displaying apparatuses and methods for controlling the same and, more particularly, to a displaying apparatus capable of adjusting the brightness of pictures and a method for controlling the same.

2. Related Art

In the present day, end users prefer to see moving pictures or photographs of good quality from computer monitors. Further, users want to see a variety of data supplied from a computer through a TV set. Users seek a feature whereby data can be viewed both through the monitor and through the TV.

To satisfy the user's need, photographs and moving pictures of good quality which can be used both in the monitor and in the TV have been produced, and these data have been supplied to a number of users via the Internet.

The users prefer to see such moving pictures and photo data more brightly and vividly. Some users have been more satisfied with seeing the moving pictures and photos through a TV, which has better sharpness, rather than through a monitor. Monitor users have not been satisfied with a deterioration in the quality of text, provided through word processors or spreadsheets, etc., due to brightness of the monitor.

For this reason, users want a monitor which is capable of providing a high quality of In moving pictures and photographs, and which causes no deterioration in the quality of text documents, thereby enhancing the resolution of pictures.

Typically, a displaying apparatus employs a brightness controller to control or adjust brightness of a picture being displayed. However, such a brightness controller has the disadvantage of being usable only with certain system programs. Other disadvantages include provision of a brightness control capability which is relatively weak, which does not compensate for changes in the frequency of video signals, which is difficult for the user to use, and which does not work for certain specific colors.

### SUMMARY OF THE INVENTION

Accordingly, the present invention has been developed while keeping in mind the above-mentioned problems, and an object of the present invention is to provide a displaying apparatus capable of specifying a portion of a picture in a displaying part, and randomly adjusting the brightness thereof without separate software, and to provide a method for controlling such a displaying apparatus.

These and other objects of the present invention may be achieved by provision of a displaying apparatus comprising: a displaying part for displaying a picture; a selection input part for selecting for display a highlight portion of the picture of the displaying part; a storage part for storing data according to the selection made through the selection input part; and a controller for generating a highlight signal corresponding to the highlight portion based on the selected data, Ins for composing or combining the highlight signal with the video signals to thereby generate At composed or combined video signals, and for displaying the highlight portion within the picture of the displaying part based on the composed or combined video signals.

Preferably, the controller adds the highlight signal to the video signals to thereby in increase the level of the composed or combined video signal of the highlight portion, and the controller subtracts the highlight signal from the video signals to thereby decrease the level of the composed or combined video signal of the highlight portion.

Preferably, the selection input part comprises a size control key for controlling the size of the highlight portion and a position control key for controlling the position of the highlight portion.

As a further preference, the highlight signal comprises at least one color signal corresponding to the video signals, and the selection input unit comprises a signal control key for controlling the level of the color signal(s).

According to another aspect of the present invention, these and other objects of the present invention may be achieved by provision of a method for controlling a displaying apparatus, the method comprising the steps of: selecting for display a highlight portion of the picture of the displaying part; generating a highlight signal corresponding to the highlight portion; composing or combining the highlight signal with the video signals to thereby generate a composed or combined video signal; and displaying the highlight portion within the picture of the displaying part.

Preferably, the method further comprises the step of storing the data selected in the selection step.

As a further preference, the composing or combining step comprises the steps of adding the highlight signal to the video signals to thereby increase the level of the composed or combined video signal, and eliminating the highlight signal from the video signal to thereby decrease the level of the composed or combined video signal.

The method further comprises the step of controlling the size of the highlight portion and the position thereof. The highlight signal comprises at least one color signal corresponding to the video signals, and the method further comprises the step of controlling the level of the color signal(s).

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, and wherein:

FIG. 1 is a control block diagram of a displaying apparatus according to the present invention;

FIG. 2 is a detailed control block diagram of FIG. 1;

FIG. 3 is a picture diagram of a displaying part with a highlighted portion according to the present invention;

FIG. 4 is a control flow chart according to the present invention;

FIG. 5 is a waveform diagram showing a vertical signal input in cooperation with the control flow of FIG. 3;

FIG. 6 is a waveform diagram showing a horizontal signal input in cooperation with the control flow of FIG. 3; and

FIG. 7 is a control block diagram of a displaying apparatus.

### DETAILED DESCRIPTION OF THE PREFERRED EMBODIMENTS

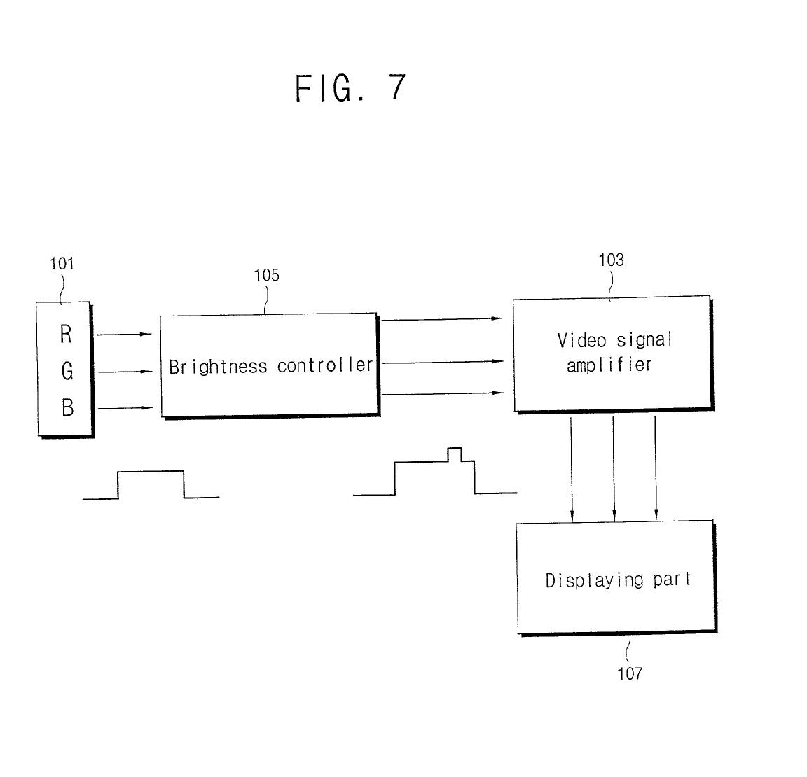

This invention will now be described in more detail with reference to the drawings, in which FIG. 7 is a control block diagram of a displaying apparatus used to enhance the resolution of pictures, and that displaying apparatus will now be described in detail with reference to FIG. 7.

As shown therein, the displaying apparatus comprises a signal input part 101 for receiving video signals (that is, R, G & B (Red, Green & Blue) signals), a video signal amplifier 103 for amplifying the video signals from the signal input part 101, a main amplifier (not shown) for re-amplifying the video signals amplified through the video signal amplifier 103, and a displaying part 107 for displaying pictures based on the signals re-amplified by the main amplifier. The displaying apparatus further comprises a brightness controller 105 disposed between the signal input part 101 and the video signal amplifier 103 for controlling the if brightness of a picture in a portion of the displaying part 107. The brightness controller 105 is operated by an operating system (OS) program installed in a computer (not shown) and separate software for controlling the brightness of the pictures of the displaying part 107 in communication with the brightness controller 105.

However, this displaying apparatus has a limitation in that the brightness controller 105 can be used only with specific OS programs. That is, the brightness controller 105 cannot be used with programs generally used by computer-aided design (CAD) users or CAD designers, etc. Since the brightness controller 105 cannot be substantially supported by UNIX or LINUX operating systems, it is difficult to achieve broad use of the controller 105.

In the displaying apparatus described above, when a user selects a brightness control function while operating with a plurality of active windows, he or she is unlikely to determine or designate the active window on which the brightness controller is to act. Further, since the frequency of the video signals is preset, it is not easy to respond to a change in the frequency of those signals.

In addition, the brightness controller employed in the displaying apparatus described above has a fixed picture brightness, making it difficult for the user to control the picture brightness as desired. Moreover, the brightness controller employed in such an apparatus cannot conduct brightness adjustment for specific colors.

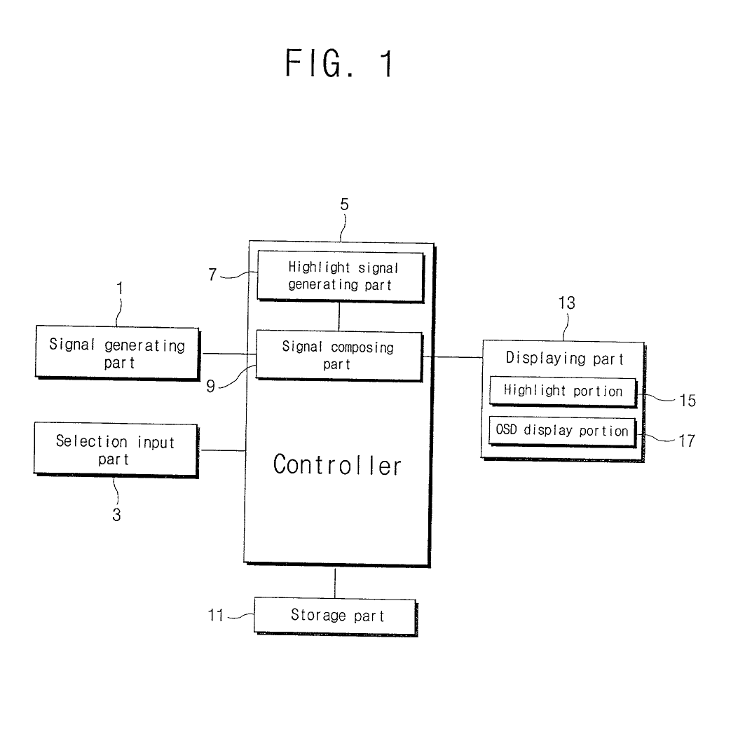

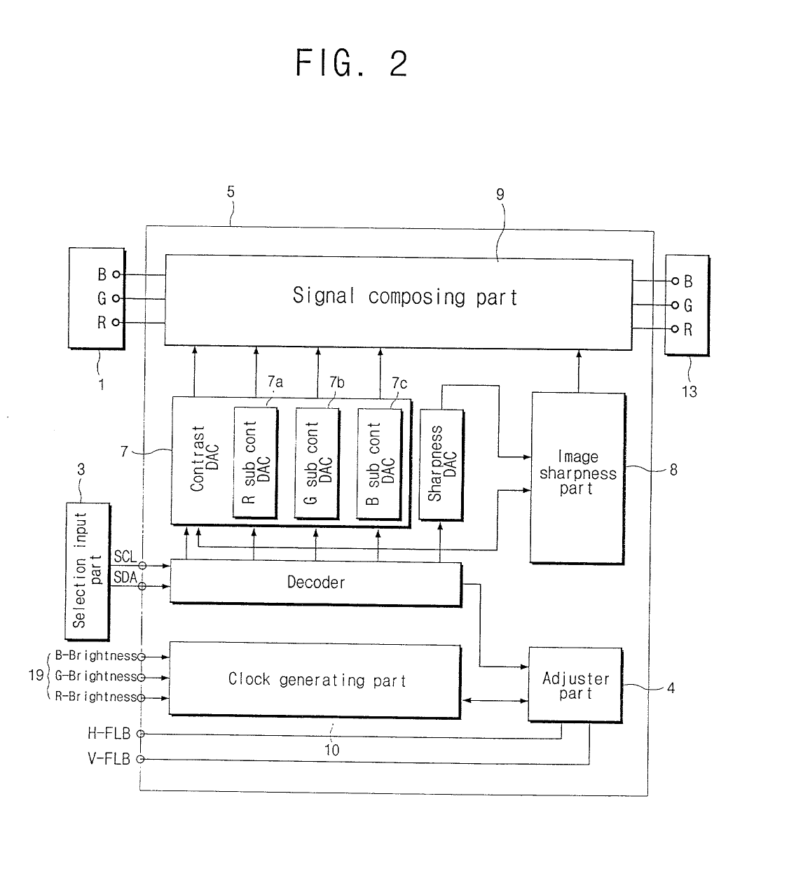

FIG. 1 is a control block diagram of a displaying apparatus according to the present invention, and FIG. 2 is a detailed control block diagram of FIG. 1.

As shown in FIGS. 1 and 2, a displaying apparatus according to the present invention comprises a signal generating part I for generating video signals (that is, R, G and B signals), and a displaying part 13 for displaying pictures based on the video signals generated by the signal generating part 1. The displaying apparatus further comprises a selection input part 3 for selecting for display a highlight portion 15 (“To highlight”) within a picture of the displaying part 13, and a storage part 11 for storing data selected by the selection input part 3.

The displaying apparatus also comprises a controller 5 for storing the data selected by the selection input part 3 in the storage part 11, and for generating a highlight signal corresponding to the highlight portion 15 based on the selected data.

Referring to FIG. 2, the controller 5 comprises a highlight signal generating part 7 for generating the highlight signal, an image sharpness part 8 for adjusting the signal size representing a borderline of the highlight portion 15, a signal composing part 9 for composing or combining the highlight signal generated by the highlight signal generating part 7 and the video signals from the signal generating part 1, a clock generating part 10 for generating a clock signal to set up a position and a size of the highlight portion 15 based on the generated clock, and an adjuster part 4 for receiving the clock signal generated from the clock generating part 10 and for adjusting a size of the clock signal according to the control signal from the selection input part 3. The controller 5 further comprises input terminals 19 for controlling sizes of the R, G & B signals, respectively, thereby enabling the controller to control the brightness of the R, G & B signals, respectively.

The highlight signal generating part 7 comprises an R highlight signal generating part is 7a, a G highlight signal generating part 7b, and a B highlight signal generating part 7c corresponding to the R, G and B signals, respectively, and controls the R, G & B highlight signal lab generating parts 7a, 7b and 7c, respectively, to adjust the sizes of the R, G & B signals, respectively.

The image sharpness part 8 adjusts the signal size representing the borderline of the highlight portion according to a selection by the selection part 3, and supplies the adjusted signal size to the signal composing part 9.

The signal composing part 9 composes or combines the original R, G and B signals, the highlight signals of R, G and B outputted from the highlight signal generating part 7, and borderline signals indicating the borderline of the highlight portion 15 outputted from the image sharpness part 8, and part 9 outputs the highlight signal to indicate the highlight portion 15.

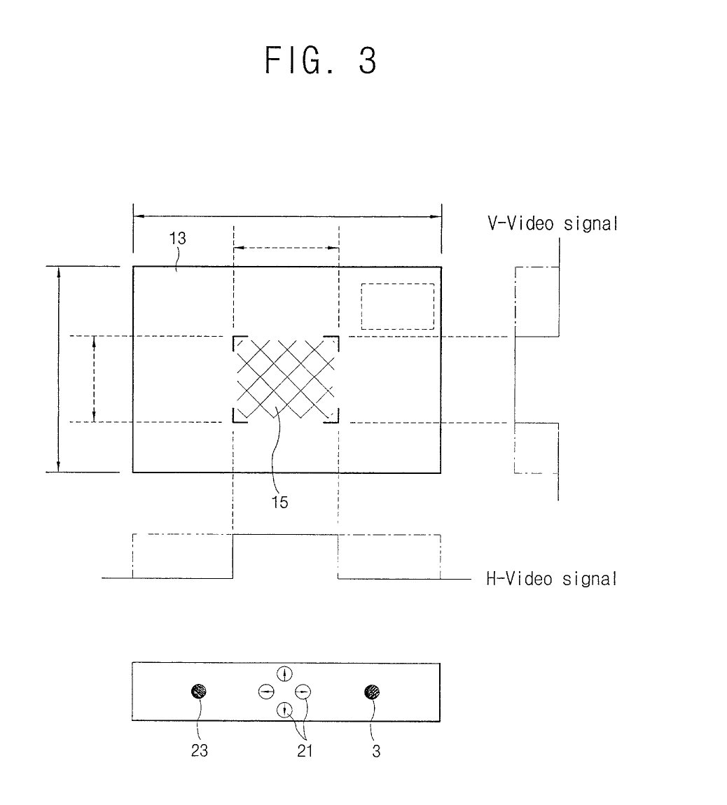

Referring to FIG. 3, the displaying part 13 comprises an on screen display (OSD) selecting part 23 and a control key part 21 for controlling a size and a position of the highlight portion 15.

The control key part 21 comprises a size control key for controlling the size of the highlight portion 15, a position control key for controlling the position of the highlight portion 15, and a signal control key for controlling the value of the highlight signals in the highlight portion 15. The controller 5 further comprises an adjuster part 4 (FIG. 2) for adjusting a picture in response to external signals adjusted by the control key part 21.

If a user selects “To Highlight” through the selection input part 3 (see FIG. 1), the highlight signals are supplied to the adjuster part 4 through an SCL and an SDA (see FIG. 2), and the highlight portion 15 is marked in one portion of the displaying part 13. If the highlight portion 15 is displayed, the size, location and color of the highlight portion 15 are adjusted through the control key part 21. Referring to FIG. 3, the highlight portion 15 is located in the middle of the displaying part 13. However, the location and size of the highlight portion 15 can be specified as desired. The size and location of the highlight portion 15 is initially determined based on the reference clock signal generated by the clock generating part 10.

The user can select an OSD display through the OSD selection part 23 (FIG. 3), but both an OSD display portion 17 and the highlight portion 15 can be displayed simultaneously. Where the OSD display portion 17 and the highlight portion 15 are selected simultaneously, it is desirable to prevent both portions from overlapping each other.

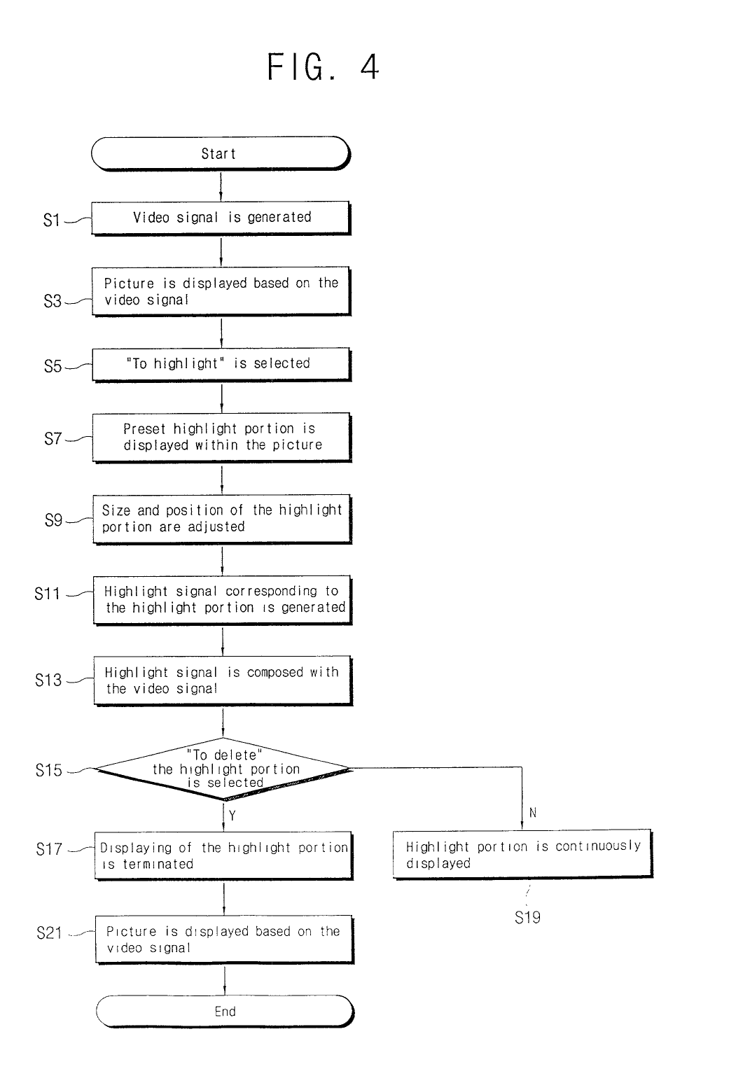

Referring to FIGS. 4 thru 6, a control flow of the displaying apparatus according to the present invention will be described in detail. As shown therein, if the displaying apparatus is initiated by means of external power supplied thereto, video signals are generated by the signal generating part 1 (S1). A picture is displayed in the displaying part 13 based on the inputted video signals (S3). If the “To Highlight” feature is selected by the user through the selection input part 13 (S5), the controller 5 stores the selected data in the storage part 11, and the preset highlight portion 15 is then displayed within the picture of the displaying part 13 (S7).

If the highlight portion 15 is displayed within the picture, the user adjusts the size and position of the highlight portion 15 through the control key part 21 (S9). Then, the controller 5 generates highlight signals corresponding to the highlight portion 15 through the highlight signal generating part 7 (S11). If highlight signals are generated, the controller 5 composes or combines the highlight signals and the video signals through the signal composing part 9, to thereby generate a composed or combined video signal (S13). The brightness of the highlight portion 15 can be indicated based on the composed or combined video signal.

The controller 5 determines whether a function to delete the highlight portion 15 (“To Delete”) is selected through the selection input part 3 (S15). If the function “To Delete” is is selected, display of the highlight portion 15 in the displaying part 13 terminates (S17). Then, the picture is displayed based on the video signals generated by the signal generating part 1 (S21). Conversely, if the function “To Delete” is not selected, the highlight portion 15 is continuously displayed in the displaying part 13 (S19).

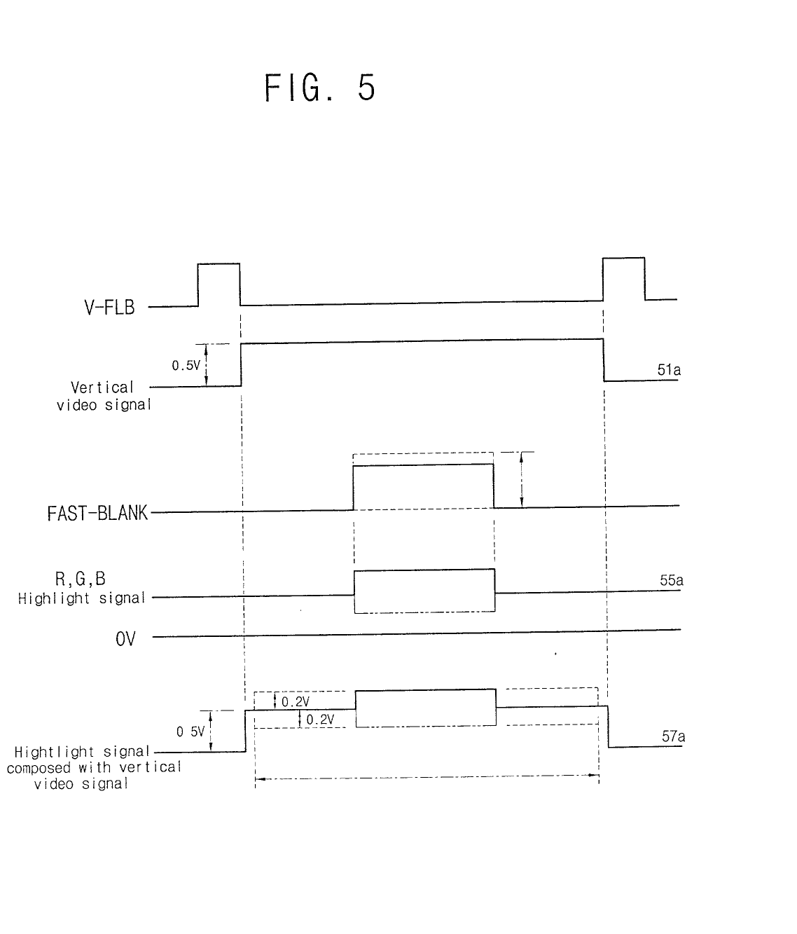

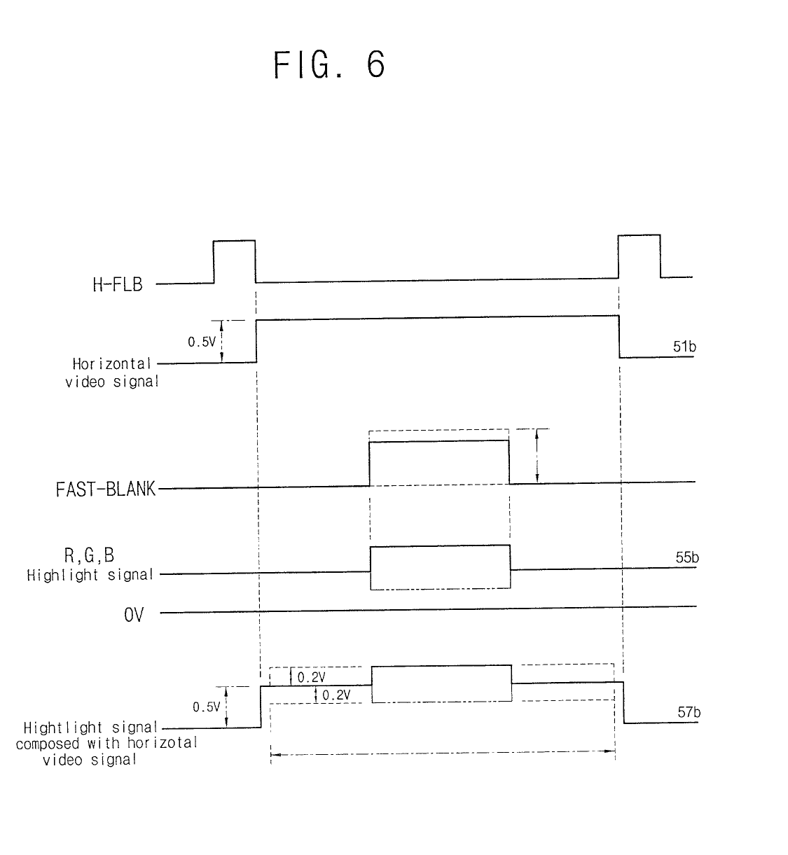

As shown in FIGS. 5 and 6, the video signals which are generated from the signal generating part 1 and supplied to the displaying part 13 in step S1 are R, G & B signals having their specific voltages. If “To Highlight” is selected through the selection input part 3 in step S5, the highlight portion 15 is displayed in a portion of the displaying part 13. The size and portion of the highlight portion 15 can be adjusted through the size control key and the position control key, respectively. If the size and the position of the highlight portion 15 are adjusted, the highlight signal generating part 7 generates highlight signals having a level of voltage sufficient to maintain the brightness of the picture as desired. The generated highlight signals are composed or combined with the video signals, to thereby generate composed or combined video signals. For example, if the video signal voltages are supplied with 0.5 V and the highlight signal voltages are supplied with 0.2 V, the voltage of the highlight portion 15 is 0.7 V, thereby making the picture brighter.

In the above-described embodiment of the present invention, the highlight portion 15 is displayed brighter than other portions of the displaying part 13 by adding the video signals and the highlight signals to adjust the brightness. However, the highlight portion 15 may be displayed darker than other portions of the displaying part 13 by eliminating the highlight signals from the video signals. In addition, selection of “To Highlight” and adjustment of the size, position and the brightness of the highlight portion 15 can be controlled by a mouse or a keyboard.

As described above, according to the present invention, there is provided a displaying apparatus capable of adjusting the size, position and brightness of a highlight portion, as desired, by specifying the highlight portion within a picture of a displaying part. According to the invention, there is also provided a method for controlling such a displaying apparatus. Further, since a user can adjust the respective values of R, G & B signals, the color of the highlight portion can be easily adjusted, thereby allowing the user to see image pictures, such as moving pictures or photographs, etc, with a desired brightness selected by the user.

Although the preferred embodiments of the present invention have been disclosed for illustrative purposes, those skilled in the art will appreciate that various modifications, additions and substitutions are possible without departing from the scope and spirit of the invention as recited in the accompanying claims.

What is claimed is:

1. A displaying apparatus, comprising:
a displaying part for displaying a picture;
a selection input part for selecting for display a highlight portion within the picture of the displaying part;
a storage part for storing data according to the selection made through the selection input part; and
a controller for generating a highlight signal corresponding to the highlight portion based on the selected data, for composing the highlight signal with video signals to thereby generate composed video signals, and for displaying the highlight portion within the picture of the displaying part based on the composed video signals.

2. The displaying apparatus according to claim 1, wherein the controller adds the highlight signal to the video signals to thereby increase the level of the composed video signals of the highlight portion.

3. The displaying apparatus according to claim 1, wherein the controller subtracts the highlight signal from the video signals to thereby decrease the level of the composed video signals of the highlight portion.

4. The displaying apparatus according to claim 1, wherein the selection input part comprises a size control key for controlling a size of the highlight portion.

5. The displaying apparatus according to claim 4, wherein the selection input part comprises a position control key for controlling a position of the highlight portion.

6. The displaying apparatus according to claim 5, wherein the highlight signal comprises at least one color signal corresponding to the video signals; and
the selection input part comprises a signal control key for controlling a level of said at least one color signal.

7. The displaying apparatus according to claim 4, wherein the highlight signal comprises at least one color signal corresponding to the video signals; and
the selection input part comprises a signal control key for controlling a level of said at least one color signal.

8. The displaying apparatus according to claim 1, wherein the highlight signal comprises at least one color signal corresponding to the video signals; and
the selection input part comprises a signal control key for controlling a level of said at least one color signal.

9. The displaying apparatus according to claim 1, wherein the selection input part comprises a position control key for controlling a position of the highlight portion.

10. The displaying apparatus according to claim 9, wherein the highlight signal comprises at least one color signal corresponding to the video signals; and
the selection input part comprises a signal control key for controlling a level of said at least one color signal.

11. A method for controlling a displaying apparatus, comprising the steps of:
selecting for display a highlight portion within a picture of the displaying apparatus;
generating a highlight signal corresponding to the highlight portion;
composing the highlight signal with video signals to thereby generate composed video signals; and
displaying the highlight portion within the picture of the displaying apparatus.

12. The method according to claim 11, further comprising the step of storing data selected in the selecting step.

13. The method according to claim 11 wherein the composing step comprises adding the highlight signal to the video signals to thereby increase a level of the composed video signals.

14. The method according to claim 1, wherein the composing step comprises eliminating the highlight signal from the video signals to thereby decrease a level of the composed video signals.

15. The method according to claim 11, further comprising the step of controlling a size of the highlight portion.

16. The method according to claim 15, further comprising the step of controlling a position of the highlight portion.

17. The method according to claim 16, wherein the highlight signal comprises at least one color signal corresponding to the video signals;
said method further comprising the step of controlling a level of said at least one color signal.

18. The method according to claim 15, wherein the highlight signal comprises at least one color signal corresponding to the video signals;
said method further comprising the step of controlling a level of said at least one color signal.

19. The method according to claim 11, further comprising the step of controlling a position of the highlight portion.

20. The method according to claim 19, wherein the highlight signal comprises at least one color signal corresponding to the video signals;
said method further comprising the step of controlling a level of said at least one color signal.

21. The method according to claim I11, wherein the highlight signal comprises at least one color signal corresponding to the video signals;
said method further comprising the step of controlling a level of said at least one color signal.
